(19) United States
(12) Patent Application Publication
(10) Pub. No.: US 2008/0030476 A1
(43) Pub. Date: Feb. 7, 2008

(54) Mobile device with software-based keypad

(76) Inventor: Suresh Raj V.A., Tamil Nadu (IN)

Correspondence Address: FAY KAPLUN & MARCIN, LLP, 15O BROADWAY, SUITE 702, NEW YORK, NY, 10038, US

(21) Appl. No.: 11/500,059

(22) Filed: Aug. 7, 2006

(51) Int. Cl. G06F 3/041

(52) U.S. Cl. 345/173

(57) ABSTRACT

A mobile device may include a touch-sensitive display and a data input overlay covering at least a portion of the display. The overlay defines a plurality of data input keys. A first location of each of the keys is associated with a second location on the display. Coordinates of the second location on the display are associated with a predetermined function identified by the corresponding key.

### FIELD OF THE INVENTION

The present invention generally relates to mobile devices with keypads.

### BACKGROUND INFORMATION

Mobile devices often include physical keypads in addition to touch-sensitive displays, which are generally less durable than the physical keypads. Where durability is a concern, a physical keypad offers an alternative to using a touch-sensitive display as an input device. However, including the physical keypad requires additional hardware, increasing a size and/or cost of a mobile device.

FIG. 1 shows a conventional mobile unit (“MU”) 100. The MU 100 may be a vehicle/fix mounted mobile computer located in a warehouse, a loading station, etc. The MU 100 includes a touch-sensitive display (e.g., a touch screen display 110) and a physical keypad (e.g., a keypad 120). The MU 50 may include computing components such as a processor, a memory, a hard drive, a wireless communications arrangement (e.g., a wireless transmitter and/or receiver), etc. The MU 100 may also include a mounting arrangement 130 coupled to a base 140, which secures the MU 100 to a vehicle (e.g., a cart, a forklift, etc.) or a fixture (e.g., a wall, a beam, a pole, etc.). The mounting arrangement 130 may be rotatable along one or more axes, allowing the MU 100 to be repositioned.

The display 110 may comprise a resistive, a capacitive, an infrared, or other touch screen known in the art. The display 110 captures user input when a portion of the display 110 is pressed. For example, if the display 110 is the resistive touch screen, a user may engage the display 110 using a finger, a stylus, or any other pressure-producing instrument. The display 110 may utilize a particular resolution standard such as Video Graphics Array (“VGA”), Super Video Graphics Array (“SVGA”), Ultra extended Graphics Array (“UXGA”), etc. and may be configured to display images in a particular screen resolution (e.g., 800×600, 1280×1040, etc.).

The keypad 120 may include a data input overlay 122, which is disposed within a keypad housing 124 and comprises one or more keys 128. In one embodiment, the keys 128 are soft keys formed of a flexible rubber or plastic. However, the keys 128 may be constructed according to desired characteristics (e.g., hardness, flexibility, responsiveness, etc.) and in other embodiments, may not be soft keys. As would be understood to one of skill in the art, the keys 128 are coupled to circuitry (e.g., a printed circuit board (“PCB”)) which senses a pressing of the keys 128 and transmits a corresponding input signal to the processor via a keypad interface (e.g., a PS/2 interface, a Universal Serial Bus (“USB”) interface, etc.).

As shown in shown in FIG. 1, a substantial portion (indicated by dashed lines) of the display 110 is obscured by the keypad 120. Placement of keypad 120 in this manner reduces an available viewing area 112 of the display 110, but eliminates a need to modify a housing of the MU 100 to accommodate the keypad 120. The obscured portion of the display 110 cannot be used as either a display or an input device. As a result, the display 11.0 must be programmed to use only the viewable portion 112. For example, if the screen resolution is 800×600, the display may be programmed to display in a non-native resolution (e.g., 800×300) in order to fit a full screen of images onto the viewable portion 112.

### SUMMARY OF THE INVENTION

The present invention relates to a mobile device which may include a touch-sensitive display and a data input overlay covering at least a portion of the display. The overlay defines a plurality of data input keys. A first location of each of the keys is associated with a second location on the display. Coordinates of the second location on the display are associated with a predetermined function identified by the corresponding key.

### BRIEF DESCRIPTION OF THE DRAWINGS

FIG. 1 shows a conventional mobile device;

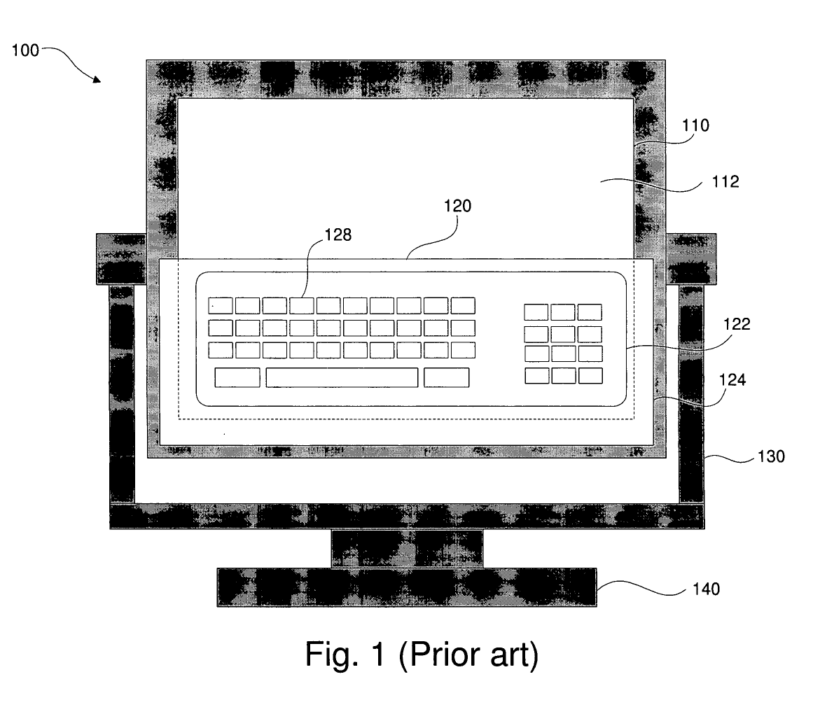

FIG. 2 is an exemplary embodiment of a mobile device according to the present invention;

FIG. 3 is an exemplary embodiment of a method according to the present invention; and

FIG. 4 is an exemplary embodiment of another method according to the present invention.

### DETAILED DESCRIPTION

The present invention may be further understood with reference to the following description and the appended drawings, wherein like elements are provided with the same reference numerals. The present invention relates to mobile devices (e.g., mobile units, (“MUs”)) with keypads. An exemplary embodiment of the present invention is described with reference to a vehicle/fix mounted mobile computer, however those skilled in the art will understand that the present invention may be implemented with any MU utilizing a touch-sensitive display, such as, for example, an RFID reader, a cell phone, an image-/laser-based scanner, a PDA, a music player, etc.

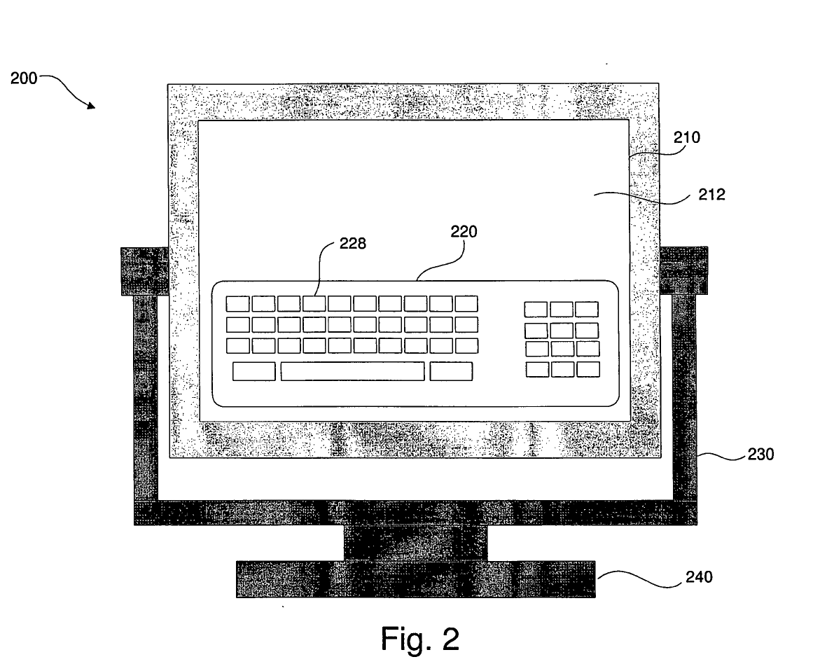

FIG. 2 shows an exemplary embodiment of an MU 200 according to the present invention. The MU 200 may include a touch-sensitive display 210, a mounting arrangement 230 and a base 240. However, the MU 200 does not include a keypad housing or keypad circuitry. A data input overlay 220 is attached directly to the display 210 and receives the user input in conjunction with the display 210, as will be described below. The overlay 220 comprises one or more keys 228 and in an exemplary embodiment, may be partially or fully transparent. For example the overlay 220 may be formed of a clear plastic or rubber, allowing the user to view the entire display 110. In other embodiments, the overlay 220 may be substantially opaque. For example, the keys 228 may be colored according to a manufacturer's or the user's specifications.

The user input, via the overlay 220, may be captured using a software input panel (“SIP”). The SIP may comprise a specialized input module of the MU 200's programming, detect the user input and translate a location of the user input to a predetermined function identified by a corresponding key 228. The translation may be performed by correlating a mapping of the display 210 with a key mapping. The translation and the input detection will be described in further detail below.

The combination of the SIP and the overlay 220 allows for utilization of the display 210. Although a viewable area 212 of the display 210 may remain unchanged, the previously not-fully-utilized portion of the display 210 may be now utilized for receiving user input. By eliminating the keypad housing 124 and all associated circuitry (e.g., the PCB, the keypad interface, etc.), manufacturing costs of the MU 200 may be reduced on a per unit basis (e.g., bill-of-materials cost). In addition, the overlay 220 shields a portion of the display 210 from damage (e.g., liquids, scratching, contaminants, etc.) without sacrificing a functionality of the original keypad 120. The overlay 220 may be permanently attached to the MU 200 or may be temporary attached (e.g., may be removed and replaced with another overlay)

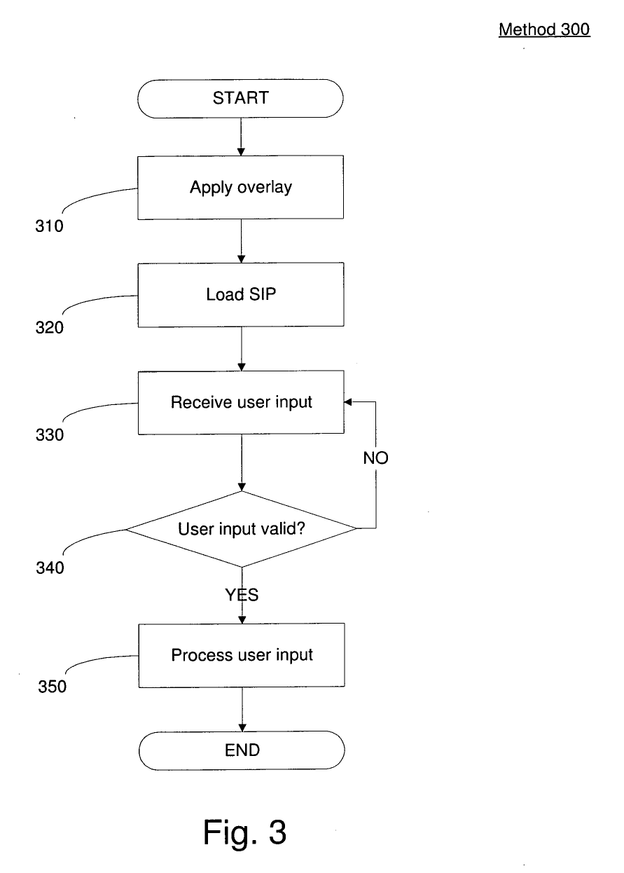

FIG. 3 shows an exemplary embodiment of a method 300 according to the present invention. In step 310, the overlay 220 is applied. Either the manufacturer or the user may perform this step. For example, the overlay 220 may be attached to the display 220 using a conventional method such as heat melding, adhesives, etc. during production of the MU 200. Alternatively, the user may attach the overlay 220 by, for example, wrapping the overlay 220 around the MU 200 (e.g., via a strap, a clip, a snap-on arrangement), aligning an adhesive-coated surface of the overlay 220 with the display 210, using Velcro®, etc.

In step 320, the SIP is loaded. The loading may comprise reading an SIP configuration from memory (e.g., a database, a read-only memory (“ROM”), etc.). The loading can be performed by an operating system when the MU 200 is powered-on. After the SIP is loaded, the MU 200 enters a ready state for accepting the user input.

In step 330, the user input is received. For example, the user presses on a button of the overlay 220. An analog signal corresponding to the user input may be converted to a digital signal representing a coordinate (e.g., XY coordinates) on the display 210. The SIP then receives and processes the coordinate signal.

In step 340, the MU 200 determines whether the user input is valid. The display coordinate signal is compared to the key mapping of the overlay 220 and the SIP attempts to match the display coordinate to a location of a corresponding key 228. If no match is found, the MU 200 returns to a ready state and awaits a subsequent user input. In other embodiments, the SIP may produce an error message or alert (e.g., an audio alert) indicating that the input is invalid before the MU 200 returns to the ready state. If the match is found, a control may be passed to the operating system, which determines if the corresponding key 228 is a valid choice. For example, if the operating system is expecting an alphanumeric input and the corresponding key 228 is a function key, the user input is invalid. However, if the user input is valid (step 350) the input is processed accordingly.

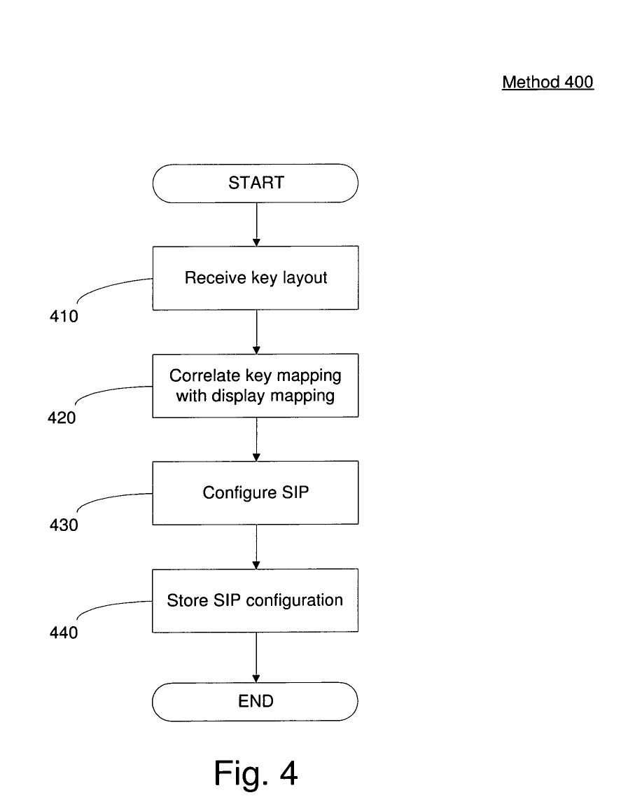

FIG. 4 shows an exemplary embodiment of a method 400 according to the present invention. The method 400 illustrates how the SIP may be configured by, e.g., the manufacturer, the user, a system administrator, etc. In step 410, a key layout of the overlay 220 is received. The key layout includes the key mapping and may also include other information (e.g., colors, textures, response characteristics, etc.) relating to a design of the overlay 220. The key layout may be created according to the user's specifications. For example, the user may specify the key mapping, which includes dimensions and coordinates for each key 228. The user may further specify a color scheme for the keys 228, specific response characteristics of the keys 228, etc.

In step 420, the key mapping is correlated with the display coordinates (e.g., display mapping). Each key 228 is associated with corresponding coordinate (e.g., coordinates of one or more pixels) of the display 210 in accordance with the dimensions and location of the key 228. That is, a location of each key 228 is associated with one or more coordinates of the display 210. The correlation may be performed by the operating system or with an external design software such as a computer-aided design (“CAD”) program which converts the key layout to display coordinates. In another embodiment, the correlation may be performed and/or adjusted by engaging the keys 228. For example, the programmer may press one or more keys 228 disposed at predetermined locations (e.g., at each corner, at a center, etc.) of the overlay 220. The correlation is then adjusted by determining the positions of the remaining keys 228 relative to the positions of the pressed keys 228. Thus, the correlation may be updated to reflect changes in a position of the overlay 220 relative to the display 210. The programmer may perform the correlation manually by pressing each key 228 and specifying a corresponding function (e.g., an alphanumeric character, a special function, etc.).

In step 430, the programmer configures the SIP. The configuration may include selecting a response characteristic for the keys 228. For example, the response characteristic may be an audio response (e.g., playing a particular tone), a signal response (e.g., a continuous signal, a fixed-duration signal, a repeating signal, etc.), or a function response (e.g., a particular alphanumeric character, a special function, etc.). In an exemplary embodiment where the keys 228 are transparent, the SIP may be configured to allow the display 210 to show part or all of the keys 228 (e.g., borders, numbering/lettering, etc.). Thus, the response characteristic may also be a display response (e.g., coloring, marking, highlighting, hovering effects, etc.). After the SIP is configured, the configuration is stored in memory (step 440). The SIP may then be loaded (e.g., by the operating system) and the MU 200 enters the ready state.

In addition to being performed when the MU 200 is a first setup, the method 400 may be performed anytime thereafter. For example, if the user desires to replace the overlay 220, modify a response characteristic of a key 228, or change a configuration parameter, the steps 410-440 may be repeated.

The exemplary embodiments of the MU 200 present several advantages over the conventional MU 100. In addition to being less expensive to produce, the MU 200 may also be customized by replacing the overlay 220 with a new overlay. The overlay 220 may also be replaced if signs of wear become evident (e.g., when one or more keys 228 tear, loses a physical response characteristic, etc.).

Each overlay 220 may be customized according to the user's specifications. Instead of a universal keypad (e.g., the keypad 120), the overlay 220 may be designed specifically for a particular application. Thus, unused keys associated with the universal keypad are eliminated. Those skilled in the art will understand that the MU 200 may execute a plurality of applications. Support for the plurality of applications may be effected by replacing the overlay 220 with the new overlay. Alternatively, the MU 200 may store a plurality of SIP configurations that utilize the key mapping of the overlay 220. When the MU 200 switches to a new application, a stored SIP configuration corresponding to the new application may be loaded. Thus, the overlap 220 may not have to be replaced in order to support the plurality of applications.

Yet another advantage of the present invention lies in the fact that the MU 200 does not utilize a keypad interface. Those skilled in the art will understand that electrical components included in the keypad interface may be susceptible to damage (e.g., liquid spills, electrical shorts, etc.). In an environment where durability is a concern, the MU 200 may be resistant to damage associated with the keypad interface. For example, if liquid is spilled over the keys 228, the user may simply detach the overlay 220, wash and/or dry the overlay 220, and replace it.

The present invention has been described with reference to the above exemplary embodiments. One skilled in the art would understand that the present invention may also be successfully implemented if modified. Accordingly, various modifications and changes may be made to the embodiments without departing from the broadest spirit and scope of the present invention as set forth in the claims that follow. The specification and drawings, accordingly, should be regarded in an illustrative rather than restrictive sense.

What is claimed is:

1. A mobile device, comprising:
a touch-sensitive display; and
a data input overlay covering at least a portion of the display, the overlay defining a plurality of data input keys, a first location of each of the keys being associated with a second location on the display, coordinates of the second location on the display being associated with a predetermined function identified by the corresponding key.

2. The mobile device according to claim 1, wherein the first and the second locations and the predetermined function are stored in a readable memory as a loadable configuration.

3. The mobile device according to claim 2, further comprising a plurality of loadable configurations.

4. The mobile device according to claim 1, wherein at least one of the plurality of keys is substantially transparent.

5. The mobile device according to claim 4, wherein the mobile device is configured to produce a display response at the second location.

6. The mobile device according to claim 5, wherein the display response is produced in response to a data input at the first location.

7. The mobile device according to claim 1, wherein the association between the second location and the predetermined function is modified by:
manually engaging one of the plurality of keys;
determining a display location associated with the engaged key; and
associating a predetermined function identified by the engaged key with the display location.

8. The mobile device according to claim 1, wherein the overlay is detachably coupled to the mobile device.

9. The mobile device according to claim 1, wherein the predetermined function is user-selectable.

10. A method, comprising:
receiving, via a data input key of a data input overlay, a user input at a display location of a touch-sensitive display, wherein at least a portion of the display is covered by the overlay, the overlay defining a plurality of data input keys, an overlay location of each of the keys being associated with a corresponding display location on the display;
determining coordinates of the display location on the display;
determining a predetermined function as a function of the coordinates, the function being identified by the corresponding key; and
executing the function.

11. The method according to claim 10, wherein the first and the second locations and the predetermined function are stored in a readable memory as a loadable configuration.

12. The method according to claim 11, further comprising a plurality of loadable configurations.

13. The method according to claim 10, wherein at least one of the plurality of keys is substantially transparent.

14. The method according to claim 13, further comprising:
producing a display response at the second location.

15. The method according to claim 14, wherein the display response is produced in response to a data input at the first location.

16. The method according to claim 10, wherein the association between the second location and the predetermined function is modified by:
manually engaging one of the plurality of keys;
determining a display location associated with the engaged key; and
associating a predetermined function identified by the engaged key with the display location.

17. The method according to claim 10, wherein the overlay is detachably coupled to the mobile device.

18. The method according to claim 10, wherein the predetermined function is user-selectable.

19. The method according to claim 17, further comprising:
replacing the overlay with a second overlay having a key configuration different from that of the overlay.

20. A mobile device, comprising:
a touch-sensitive display means; and
a data input means covering at least a portion of the display means, the input means defining a plurality of data input keys, a first location of each of the keys being associated with a second location on the display means, coordinates of the second location on the display means being associated with a predetermined function identified by the corresponding key.
